(19) United States
(12) Patent Application Publication
(10) Pub. No.: US 2019/0070651 A1
(43) Pub. Date: Mar. 7, 2019

(54) HOLLOW PROFILE AND METHOD OF MANUFACTURING THEREOF FROM A HARDENED STEEL ALLOY

(71) Applicant: Benteler Automobiltechnik GmbH, Paderborn (DE)

(72) Inventors: Günter FORTMEIER, Delbrück (DE); Conrad FRISCHKORN, Paderborn (DE); Julian GRENZ, Delbrück (DE); Christian HANDING, Langenberg (DE); Christian HIELSCHER, Delbrück (DE); Thomas OLFERMANN, Salzkotten (DE)

(21) Appl. No.: 16/123,264

(22) Filed: Sep. 6, 2018

(30) Foreign Application Priority Data
Sep. 6, 2017 (DE) 10 2017 120 514.4

(51) Int. Cl. B21D 5/08; B21D 53/88; B21D 37/16

(52) U.S. Cl. CPC B21D 5/086; B21D 37/16; B21D 53/88

(57) ABSTRACT

A hollow profile and a method of producing the hollow profile from a hardenable steel alloy blank is disclosed having an L-shaped cross section with an upper vertical hollow chamber, and a lower horizontal hollow chamber, wherein the blank comes in abutment on an intermediate bridge area, forming a double layer. The hollow profile further includes, at least in regions, a tensile strength Rm greater than 1000 MPa.

### CROSS REFERENCE TO RELATED APPLICATION

The present application claims priority to German Patent Application Number 10 2017 120 514.4 filed, Sep. 6, 2017, the disclosure of which is hereby incorporated by reference herein in its entirety.

### BACKGROUND

### 1. Field of the Invention

The disclosure is related to a hollow profile produced from a hardenable steel alloy blank, a method for producing the hollow profile and, more specifically, to a battery carrier produced from the hollow profile.

### 2. Description of the Related Art

Battery carriers that are used in electric vehicles, usually in the underfloor area, are known from the prior art. A plurality of batteries is disposed in such a battery carrier for supplying the electric vehicles with electric power.

Such a battery carrier can also be referred to as a battery tray. The battery tray usually has an outer peripheral frame, wherein a bottom is connected to the frame so as to give rise to a well and so that the batteries are accommodated in said well. Usually, the battery tray is then closed with a cover. The frame can also be arranged outside, surrounding a deep-drawn well and reinforcing the same.

Extruded hollow profiles for the outer peripheral frame are used. These profiles permit the free selection of a cross-sectional geometry in the extrusion molding process. The cross-sectional geometry and the use of hard or high-strength aluminum alloys make it possible to achieve sufficient rigidity.

The production of motor vehicle components from hardenable steel alloys by thermoforming and press hardening is also known from the prior art. The steel material is heated to above AC3 temperature, formed while in this heated state, and then quickly quenched. This gives rise to a hard or high-strength material structure in the steel.

For example, DE 10 2011 051 965 A1 discloses the production of a hollow profile from a steel material and then thermoforming and press hardening this hollow profile. Internal high-pressure forming is used as a forming process, which is why this process is suitable for the production of individual motor vehicle components such as A or B columns, but not for the large-scale production of profiles in a continuous process.

For example, DE 10 2012 101 474 A1 discloses that cross-sectional geometries differing from one another in lengthwise sections can be produced on a hollow profile made of a stell material by means of a roll forming process as well as an embossing roller. These profiles produced in this manner can also be austenitized and press hardened. However, such a production process (in particular roll forming) only permits a continuous process and consequently no strength properties differing from one another in lengthwise sections. Furthermore, complex or load-optimized cross-sectional geometries are sometimes unachievable with roll forming.

### SUMMARY

According to an exemplary embodiment, the invention is embodied as a hollow profile that can be mass produced with high-strength properties partially differing from one another, as well as a process for producing the same.

According to an exemplary embodiment, the invention is embodied as a process for producing a hollow profile. The hollow profile may be embodied as a battery tray.

The hollow profile according to an exemplary embodiment is produced from a hardenable steel alloy blank by thermoforming and press hardening. 22MnB5 or other manganese-boron steels, for example, can be used as steel. The profile has an L-shaped cross section with an in particular upper vertical hollow chamber and a lower horizontal hollow chamber, wherein the blank comes in abutment on an intermediate bridge area to form a double layer, wherein the hollow profile has, at least in regions, a tensile strength Rm greater than 1,350 MPa. Although the hollow profile can also have only one hollow chamber, it is still L-shaped in cross section. This means that the one hollow chamber extends over an L-shaped cross section and that the hollow profile is formed from a sheet metal blank.

According to an exemplary embodiment, the hollow profile is produced from a blank by a press forming process. The offers the advantage that longitudinal sections with different properties and/or cross-sectional configurations can also be produced as an advantage over a roll forming process.

The hardenable steel alloy is produced either by thermoforming and press hardening. The blank, at least in regions, was thus heated above an austenitizing temperature and hardened, at least in regions, by subsequent rapid quenching.

A flange preferably projects out from the horizontal hollow chamber. Specifically, the hollow profile is closed at this flange by a joining operation. The hollow profile is preferably joined together at the flange by material coupling, in particular by spot welding. The hollow profile can also be joined together by material coupling, in particular spot welding, at the bridge area forming the double layer.

Moreover, the horizontal hollow chamber may project laterally with respect to the vertical hollow chamber. This gives rise to the L-shaped configuration in cross section.

The flange itself can be configured as a joining flange. However, joining tabs projecting with respect to the flange can also be formed. In this case it is possible to connect the hollow profile to other add-on components. If the hollow profile is formed as part of a battery tray, a bottom of the battery tray can be connected to the joining tabs. However, the bottom can also be connected directly to the flange. The flange itself can also be formed by a plurality of joining tabs. Hence, the hollow profile is only connected locally by joining tabs.

An indentation may be present on an upper portion of the vertical hollow chamber in at least one side wall, for example, on both opposite side walls. This indentation may be configured as an inward-facing bead. A further stiffening of the hollow profile is thus achievable and, in addition, the beads offer advantages during the forming operation.

An upper portion of the vertical hollow chamber, specifically a roof bridge of the vertical hollow chamber, may be configured as a soft area. This soft area is particularly distinguished by having a tensile strength Rm less than 1,000 MPa. In the case of a battery tray, it is possible to attach a cover here.

In order to save weight, the flange can also be configured largely without a double layer such that a first end of the blank forms the actual flange or the joining tab, in each case as a monolayer rather than as a double layer. In this case the opposite end of the blank is connected to the first end by a fillet weld formed by means of laser or MIG/MAG welding.

The upper vertical hollow chamber and the lower horizontal hollow chamber may be rectangular in cross section.

The locally soft areas in cross section as well as in longitudinal sections, which permit attachment by means of screws. A tearing-off of the screw connection is prevented here by the increased ductility of the soft area, specifically in the event of a crash. If a downstream perforation and/or passage-forming operation, optionally with thread cutting, is performed for producing the screw connection, a softer area here enables the perforation operation to be performed with minimum tool wear. In particular, it is thus possible to provide soft areas, in which a recess or a threaded recess for connecting other add-on components will eventually be provided. However, it is also possible to produce lines of weakness. These lines of weakness can function as crash triggers, for example. Soft cutting with minimal tool wear can also be performed on the lines of weakness.

The hollow profile thus has strengths that differ from one another areawise in cross section and/or strengths that differ from one another in longitudinal sections. The hard areas in particular have a tensile strength Rm greater than 1,100 MPa, preferably greater than 1,200 MPa, in particular greater than 1,300 MPa. However, according to the state of the art the tensile strength Rm should not exceed 2,500 MPa. In the soft areas, the hollow profile may have a tensile strength Rm less than 900 MPa, in particular less than 800 MPa, and more specifically less than 700 MPa. However, the tensile strength should be at least 500 MPa.

It is also conceivable for the hollow profile to have one or more patches. The patches would be made of a metal material. The patches may be connected to the sheet metal blank before the shaping of the same. For example, by means of resistance spot welding. The patches are then shaped jointly with the blank. As an alternative or as a supplement, a blank can also be used as a tailored blank. In particular, use is made of tailored blanks with wall thicknesses that differ from one another. For example, these can be produced by local forming, and also by local rolling. Use can also be made of tailored welded blanks, in which individual blank portions of different materials and/or with different wall thicknesses are welded together.

Inserting an insert into the hollow chambers is also conceivable. In conjunction with inserts made of metallic material, the localized arrangement of the same in the unsupported longitudinal area between two cross members or cross struts has proven to be advantageous for preventing rigidity and in particular an unacceptable penetration in certain “crush” scenarios. As an alternative, the insert can be produced from a non-metallic material, for example a plastic material or also a foam material. In the latter case, use could also be made of a metal foam. Such an insert is used in particular for further absorption of crash energy. Such an insert can be inserted in the hollow chamber, specifically after the production of the same. The insert and/or a patch can also be inserted after preforming so that the hollow chamber is formed afterwards, as depicted in FIG. 4 further below.

Furthermore, the hollow profile may have localized recesses. The horizontal hollow chamber in particular is repeatedly recessed locally so as to give rise to an outward-facing rib structure. This not only enables weight to be saved but also predetermined deformation points to be provided in a targeted fashion by the recess so that with use in a battery tray in the lateral sill region, the outward-facing horizontal hollow chamber can absorb crash energy by deformation.

According to an exemplary embodiment, a battery tray for an e-vehicle, which has an outer peripheral frame is disclosed. The outer peripheral frame is produced, at least in sections, from a hollow profile as described above. The latter are in particular the two outer sides, which lie in the area of a sill of the e-vehicle. However, the respective forward- and backward-facing end faces in the travel direction can also be produced from the hollow profile according to the invention. The battery tray then has a bottom. The bottom is in particular connected to the flange and/or to additional joining tabs of the hollow profile. A cover is also provided. The cover is preferably connected to the upper side of the vertical hollow chamber. The bottom can also be produced as a single piece with a peripheral wall by deep drawing. In this case the frame made of hollow profiles surrounds the wall.

According to an exemplary embodiment, a process for producing a hollow profile is disclosed having the following process steps:
providing of a hardenable steel alloy blank;
at least partial heating of the blank to AC3 temperature;
transferring to a thermoforming and press hardening tool or to a forming station, wherein only a portion of the blank is shaped and hardened;
transferring to another forming tool or to another forming stage of the forming station and forming of the second portion in such a way that the hollow profile is produced, wherein the second portion is optionally also thermoformed and press hardened, or wherein the first and second portions are formed and hardened, at least in regions, and the hollow profile is closed in cross section in a subsequent bending operation; and,
welding of the produced hollow profile.

According to an exemplary embodiment, the process offers the advantage that the hollow profile can be provided, in regions or partially and in a targeted fashion, with strength properties that differ from one another. A first portion of the blank is initially thermoformed and press hardened. The blank thus partially thermoformed and hardened is then transferred to another forming tool, where it is closed in particular by one or more bending operations in such a way that the hollow profile closed in cross section is produced, wherein the second portion is preferably not hardened.

It is also possible for the second portion not only to be formed, but also to be simultaneously hardened. To this end, the forming process is implemented in short cycles; hence the blank can still be thermoformed and press hardened in the second forming step. Optionally, it is possible to use, say, a heated tool in the first forming. Also, the use of an air hardenable steel would result in a hardening with bainitic structure in the second portion after the additional forming or bending. This would be followed by a welding, in particular spot welding, of the hollow profile thus produced. Optionally, additional perforation and/or punching operations can be performed.

### BRIEF DESCRIPTION OF THE DRAWINGS

For an understanding of embodiments of the disclosure, reference is now made to the following description taken in conjunction with the accompanying drawings, in which:

FIG. 1 is a cross-sectional view of a hollow profile in accordance with an exemplary embodiment;

FIG. 2 is a top view of a battery tray;

FIGS. 3a and 3b are respective cross-sectional views through a battery tray installed in a sill;

FIG. 4 is a cross-sectional view of a hollow profile during the production;

FIG. 5 is a cross-sectional view of a hollow profile with beads;

FIG. 6 is a cross-sectional view of a hollow profile during the production;

FIG. 7 is a cross-sectional view of a hollow profile during the production with soft areas in the longitudinal direction;

FIG. 8 is a cross-sectional view of a hollow profile during the production with recesses;

FIG. 9 illustrates the a production process in accordance with an exemplary embodiment;

FIGS. 10a to 10c illustrate a production process in accordance with an exemplary embodiment;

FIGS. 11a to 11h are perspective views of a hollow profile with recesses;

FIGS. 12a and 12b are top views of a battery tray;

FIG. 13 is a perspective view of a hollow profile; and,

FIGS. 14a to 14c illustrate bending points/bending areas during the production of a hollow profile.

In the figures, the same reference signs are used for identical or similar component parts, even if a repeated description is omitted for reasons of simplification.

### DETAILED DESCRIPTION OF SOME EMBODIMENTS

Some embodiments will be now described with reference to the Figures.

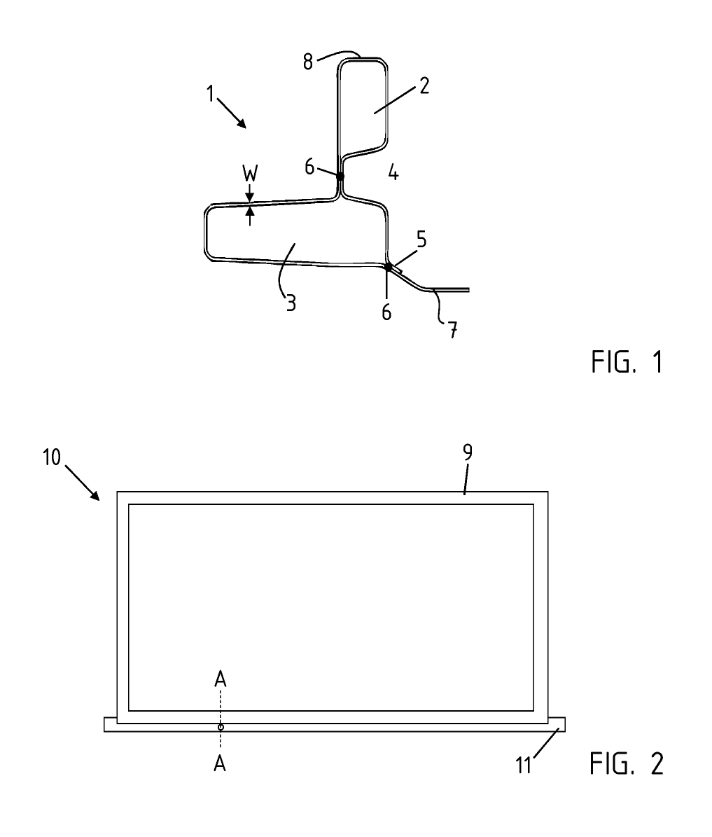

FIG. 1 shows a cross-sectional view of a hollow profile 1 in accordance with an exemplary embodiment. The hollow profile 1 has an upper vertical (in relation to the image plane and to the eventual installation position) hollow chamber 2, as well as of a lower horizontal hollow chamber 3. A bridge area 4 is formed between the upper vertical hollow chamber 2 and the lower horizontal hollow chamber 3. A blank is brought into abutment in this bridge area 4, forming a double layer.

The upper hollow chamber 2 illustrated here is essentially rectangular in cross section. The lower horizontal hollow chamber 3 lies below the vertical hollow chamber 2 and projects laterally with respect to the vertical hollow chamber 2. It is configured as slightly trapezoidal and outward tapering. This gives rise to an essentially L-shaped cross-sectional configuration of the hollow profile 2. The hollow profile 1 illustrated here has a constant wall thickness W everywhere. However, wall thicknesses differing from one another in cross section can also be formed. To this end, use can be made of, say, a tailored blank as a blank for the production. For example, this can be produced by partially rolling or mechanically ironing or welding together different blanks with different wall thicknesses and/or material properties.

Furthermore, a flange 5 protrudes laterally from the lower horizontal hollow chamber 3. A double layer is also formed in the area of the flange 5. Spot welds 6 or also laser welding can be used in attaching both the bridge area 4 and in the area of the flange 5. Furthermore, a joining tab 7 protrudes outwards with respect to the flange 5. An upper roof bridge 8 of the upper vertical hollow chamber 2 has in particular a soft material structure with a tensile strength Rm less than 1000 MPa.

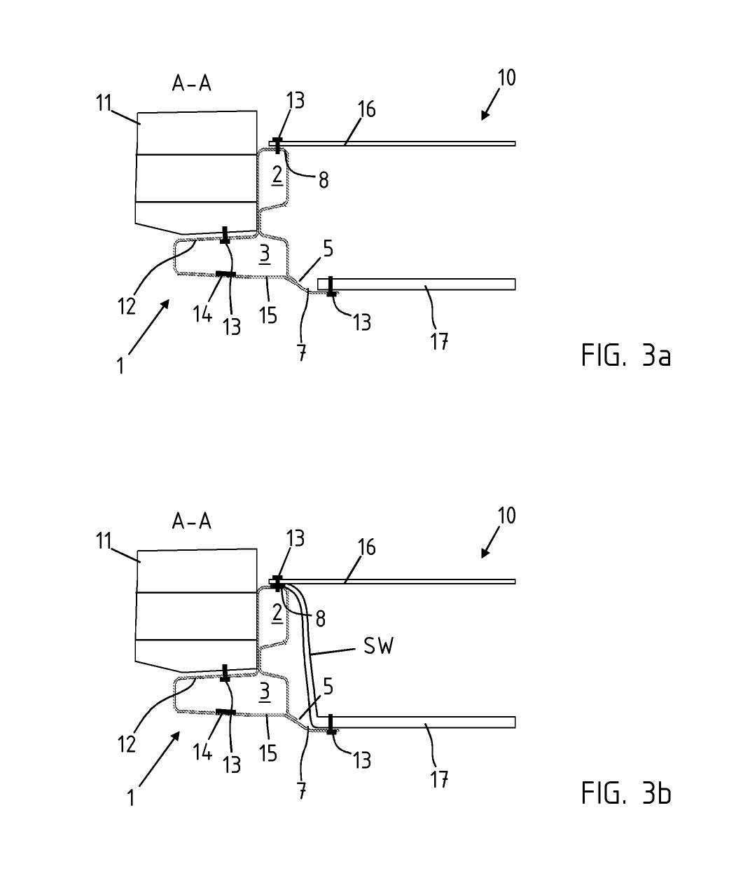

Referring now to FIG. 2, the hollow profile 1 can be arranged as an at least partial outer peripheral frame 9 of a battery tray 10. A sill 11 of a vehicle can then be designed according to the sectional view A-A, represented in FIG. 3a as a section from FIG. 2. The sill 11 is connected to an upper side wall 12, for example via a positive locking element 13 in the form of a rivet or a screw. For this purpose, there can be a recess 14 so that the attachment to the sill 11 can be made through the lower side wall 15.

Furthermore, the upper roof bridge 8 of the upper vertical hollow chamber 2 is connected to a cover 16 of the battery tray 10. The lower joining tab 7 is connected to a bottom 17 of the battery tray 10. In each case the connection is made via positive locking elements 13, for example rivets or screws. The attachment areas in which a positive locking element 13 is provided, may have a soft material structure either partially or in regions. On the one hand, this arrangement offers the possibility for performing suitable perforation operations and/or thread cutting operations. On the other hand, this arrangement offers the possibility, so to speak, for preventing a tearing out or breaking off in the event of a crash owing to a softer or ductile material structure.

Referring to FIG. 3b a deep drawn well for the battery tray is illustrated. Consequently, the side wall SW of the well itself as well as the bottom are deep drawn from a sheet metal blank as a single piece and from a single material. The hollow profile 1 thus serves as a carrier of the well and as a means of lateral strengthening or bracing. In contrast to what is depicted, the contour of the hollow profile 1 can also be configured to match the contour of the side wall SW.

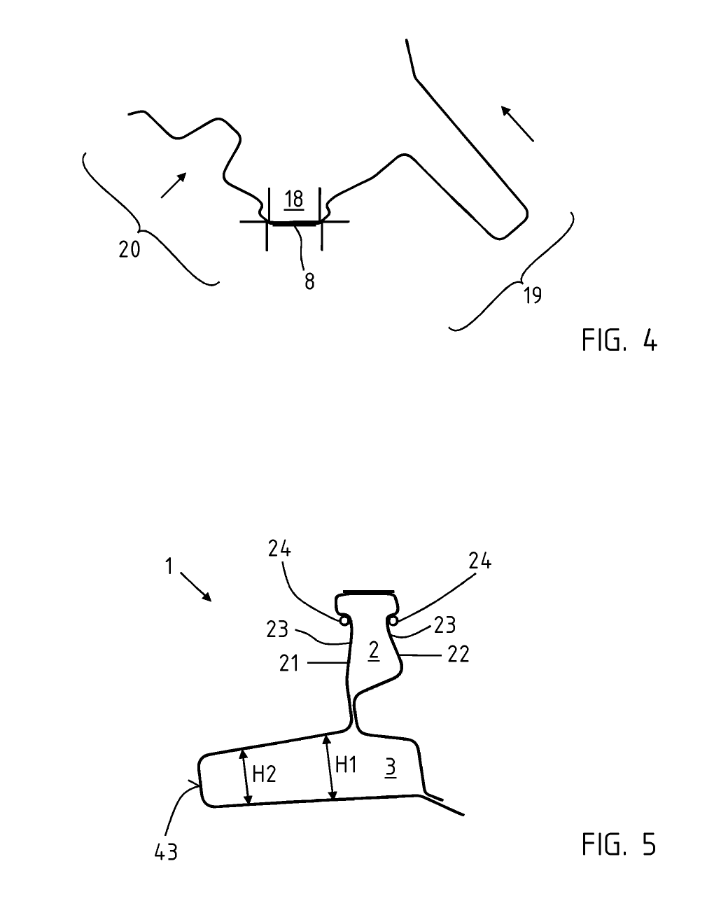

Referring to FIGS. 4 and 5, the hollow profile 1 during the production process as well as an exemplary embodiment of the hollow profile are illustrated. The eventual roof bridge 8 may be configured as a bending zone. A bending operation is implemented by indicated tools 18 on two portions 19, 20 produced beforehand by compression molding. The two portions 19, 20 can be produced simultaneously and/or at different times by forming operations by thermoforming and press hardening, so that the eventual cross-sectional contour with initially partially hard areas, but not yet the hollow profile 1, is formed. The hollow profile 1 is produced by the operation of bending about a bending zone in the region of the eventual roof bridge 8, as illustrated in FIG. 4. The hollow profile 1 illustrated in FIG. 5 is thus produced. The latter initially also has the same features as the hollow profile 1 illustrated in FIG. 1. An inward-facing bead 23 is formed on each of the opposing side walls 21, 22 of the upper vertical hollow chamber 2. Illustrated molding tools 24 ensure high dimensional stability in the area of the beads 23. The beads increase the bending stiffness of the hollow profile. The hollow profile 1 thus produced is then preferably further reinforced by cohesive joining, in particular by spot welding. The lower hollow chamber 3 preferably narrows to the outside or toward an outer wall 43. As a consequence, the height H1 decreases to the height H2. This offers advantages during production, particularly during deep drawing, but also during the quenching in the thermoforming process. The crash performance in terms of buckling behavior during a lateral collision is simultaneously improved.

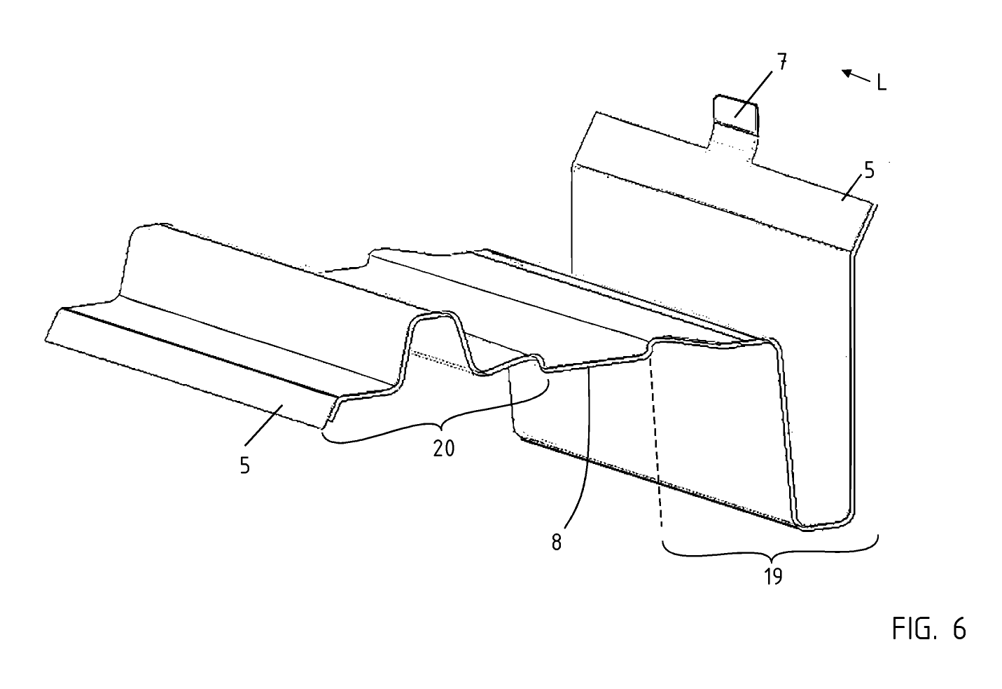

The pre-product for the subsequent implementation of the bending process is illustrated in perspective, in sections, again in FIGS. 6 to 8, in different embodiments. FIG. 6 corresponds to the embodiment variant of FIG. 4. Also illustrated is the fact that the joining tab 7 extends in a longitudinal direction L only in sections and therefore not over the entire area of the eventually formed flange 5.

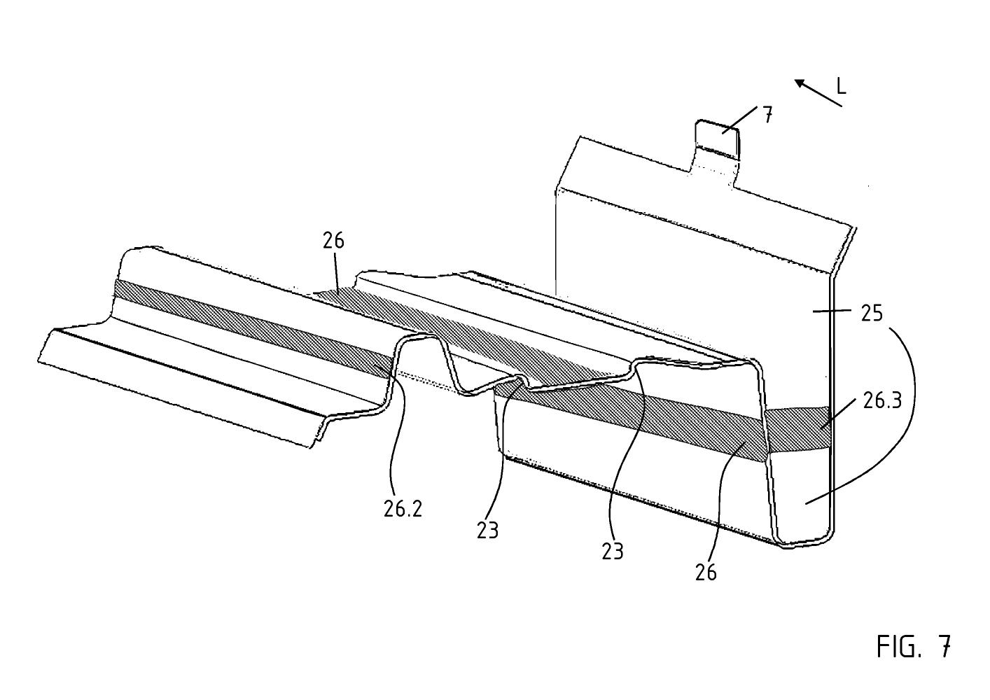

Referring to FIGS. 6 and 7, the pre-product has already been thermoformed and press hardened before the bending operation. Hard areas 25 as well as soft areas 26 (in the cross-hatched surfaces) are formed. The soft areas 26 are provided in particular for downstream bending/forming and/or perforation operations. However, as a supplement or as an alternative, the soft areas 26.2-26.3 can be used in a targeted fashion for influencing the crash behavior of the hollow profile 1.

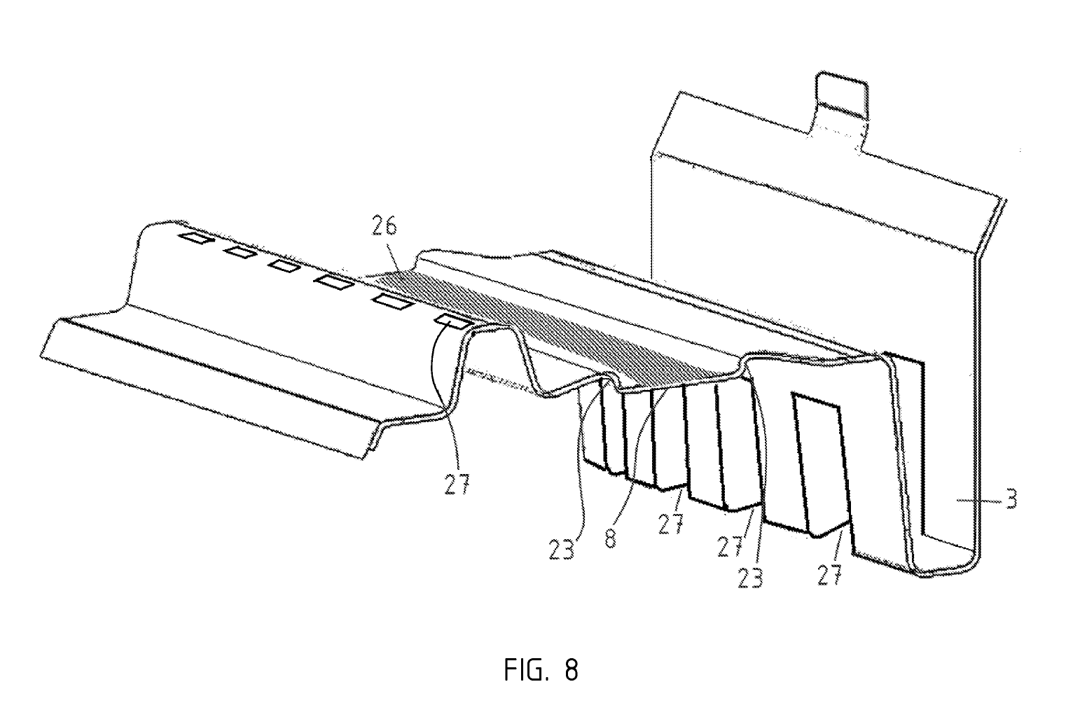

FIG. 8 a soft area 26 on the eventually formed roof bridge 8 made of additional recesses 27 so that an outward-facing rib structure is produced in the eventual horizontal hollow chamber 3 in accordance with an exemplary embodiment. This saves material and consequently also weight. Furthermore, the crash behavior can also be influenced in a targeted fashion in that the horizontal hollow chamber reduces, through deformation, a first load peak to a level non-critical for the batteries.

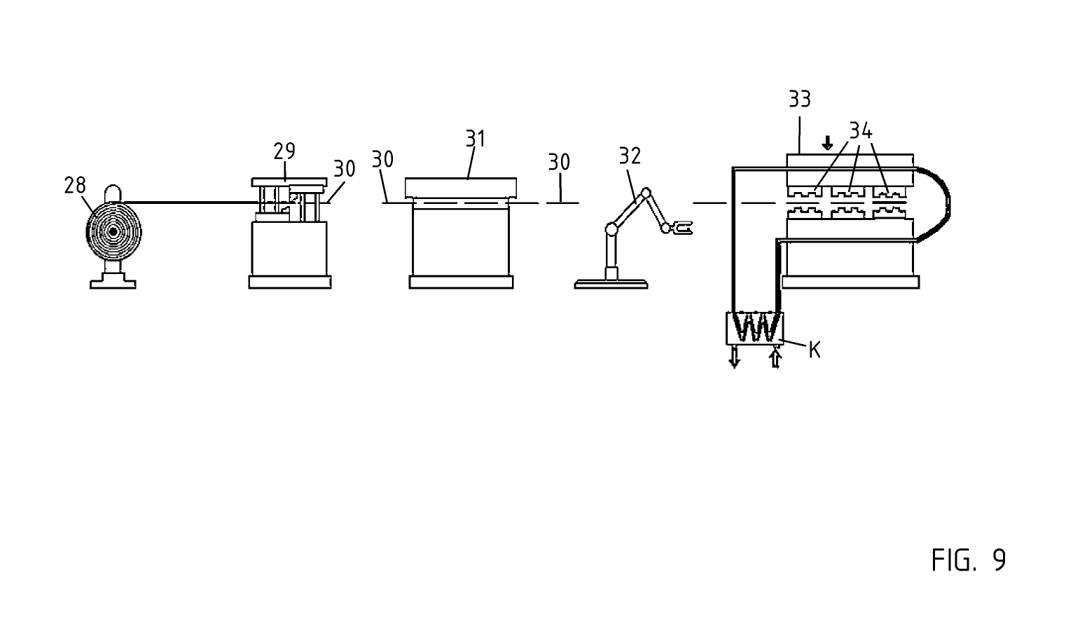

FIG. 9 shows a processing facility according to the invention during the implementation of the process. A coil material 28 is unwound and cut into individual blanks 30 on a trimming facility 29. The individual blanks 30 can then be at least partially austenitized in a temperature-control station 31. A handling robot 32 then transfers the at least partially austenitized blanks 30 to a forming station 33. The forming station 33 is multi-stage in configuration and has three forming stages 34 in total. The individual compression molding and bending operations can thus be performed sequentially in the individual forming stages. Furthermore, at least the first forming tool has a cooling circuit K so that a press hardening operation can be performed.

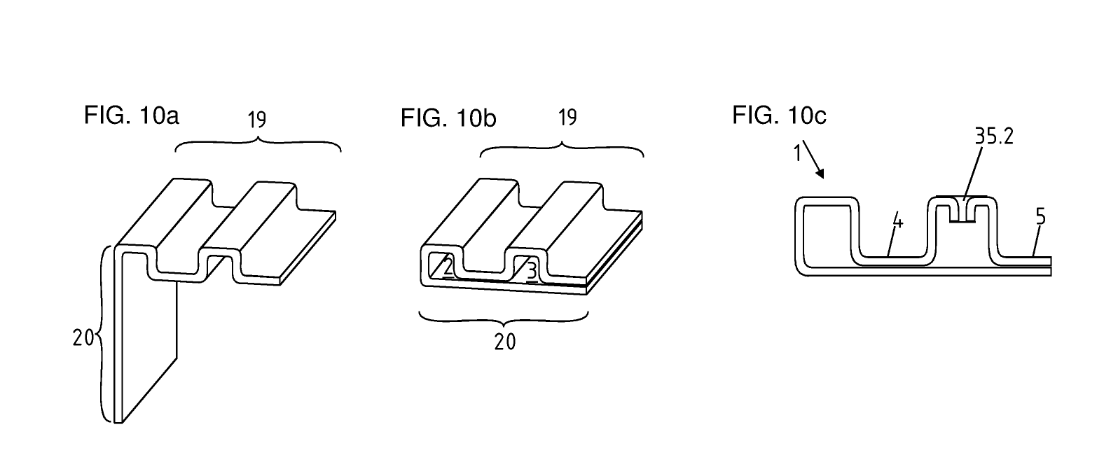

Referring to FIGS. 10a to 10c, simplified schematic representations of the forming process for producing the hollow profile 1 are illustrated. A first portion 19 is initially processed by forming technology, which in particular can be executed by thermoforming and press hardening. In this example, the second portion 20 is initially unprocessed. However, the second portion can likewise be processed by forming technology.

Referring to FIG. 10b, the second portion 20 is then brought in abutment with the first portion 19 by a bending operation so as to give rise to the individual hollow chambers 2, 3 and so that in each case double layers in a bridge area 4 as well as a flange 5 for abutment are produced.

Referring to FIG. 10c, a subsequent operation, i.e., a perforation with a peripheral collar, is performed A passage 35b is bored in order to provide, for example, a point for connecting the hollow profile 1 to another component, which is not illustrated in any greater detail.

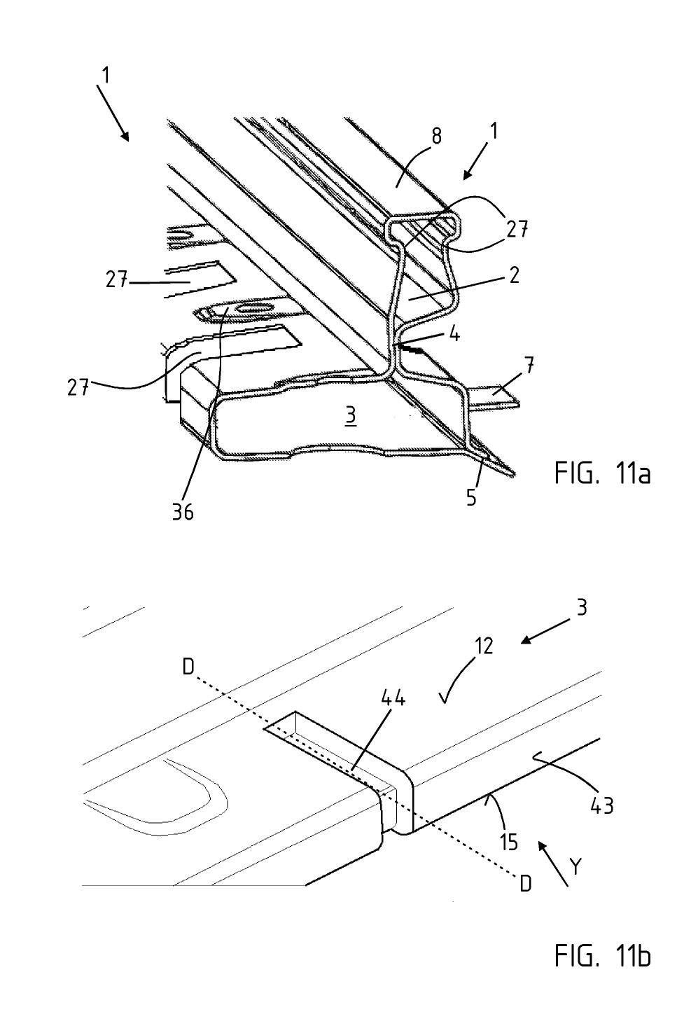

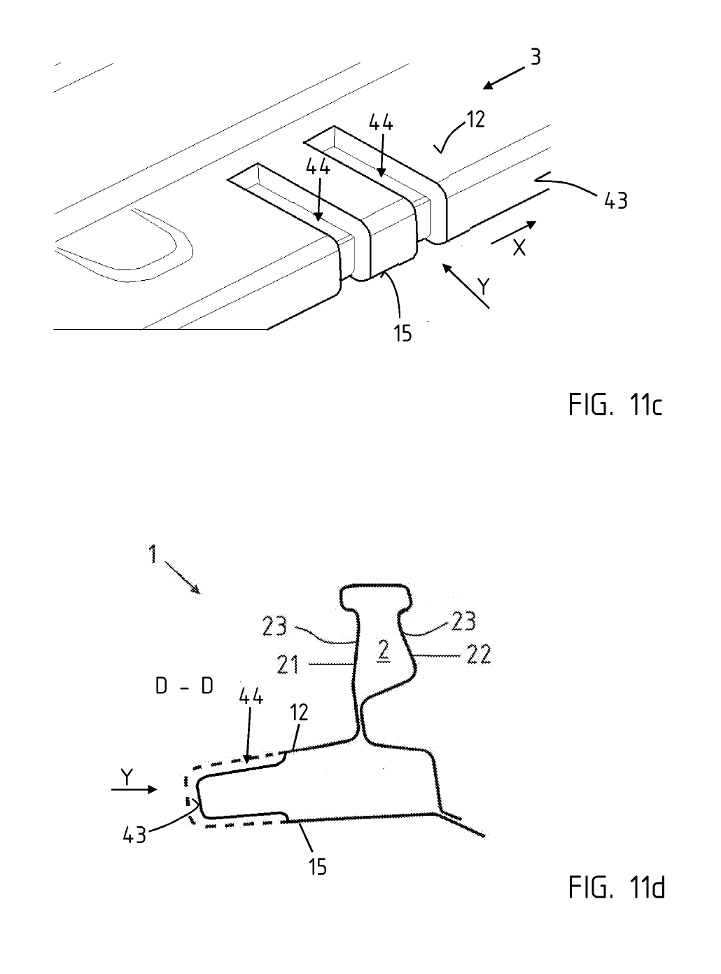

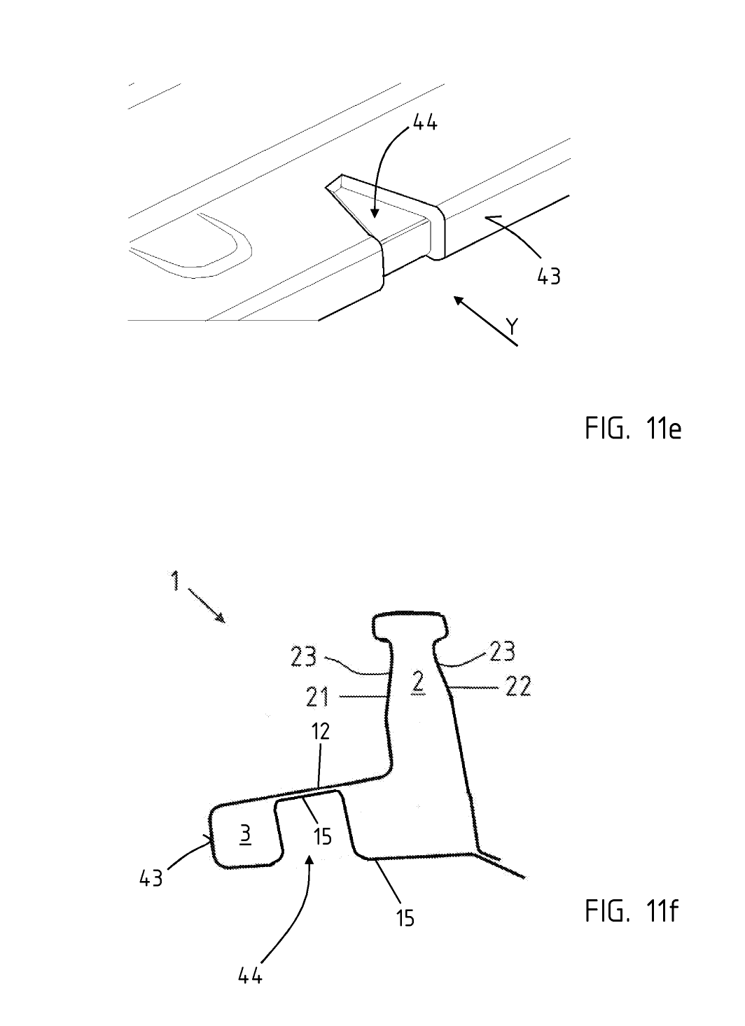

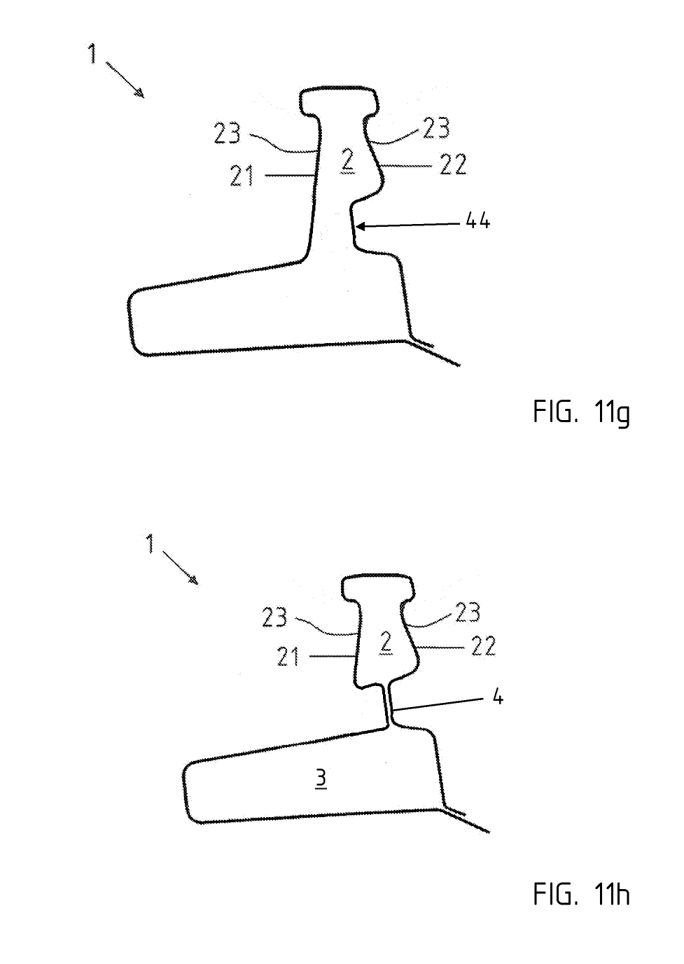

FIG. 11a shows the hollow profile 1 in a partial perspective view. In this case recesses 27 are provided on the lower horizontal hollow chamber 3. Furthermore, attachment areas 36 are formed for connection to a sill, which is not illustrated in any greater detail. FIGS. 11b and 11c show the hollow profile according to the invention, in a partial perspective view. In each case a lateral peripheral embossment 44 or impression is formed in the lower hollow chamber 3. The impression is formed such that it extends on the upper side wall 12 in the vehicle transverse direction Y, on the outer wall 43, as well as partially on the lower side wall 15, likewise in the vehicle transverse direction. The impression can be produced, for example by molding or impression, before or during the production of the hollow profile. Subsequent forming steps on the hardened component can thus be avoided. According to FIG. 11c, two embossments 44 are produced parallel to and spaced apart from each other in the vehicle lengthwise direction X. In particular, the embossments convey an increased resistance to buckling in the vehicle transverse direction Y. This counteracts staving-in or denting during a pole test or side crash test. The embossments are preferably arranged in the vehicle lengthwise direction X, at the height of a B column. FIG. 11d shows a cross-sectional view through the hollow profile 1, along the section line D-D of FIG. 11b. FIG. 11e shows an alternative design variant of the embossment 44. The latter does not run parallel in the vehicle transverse direction Y, but instead enlarges toward the outer wall 43. This enlargement is in particular v-shaped so that a larger stable impact region is provided.

FIG. 11f shows the hollow profile 1, in a cross-sectional view, in accordance with another exemplary embodiment. In this case the embossment 44 is only formed on the lower side wall 15; the upper 2 and lower hollow chambers 3 are thus divided differently. However, the hollow profile 1 as a whole is L-shaped in cross section. The upper 12 and lower side walls 15 thus form a double layer in the area of the lower leg of the 1′. The outer right vertically oriented (in relation to the image plane) hollow chamber 2 is therefore continuous. Only one small lower hollow chamber 3 is illustrated (at the left in relation to the image plane).

FIG. 11g shows the hollow profile 1, in a cross-sectional view, in accordance with another exemplary embodiment. In this case the hollow profile 1 is also L-shaped in cross section. However, there is only one hollow chamber 2. An embossment is illustrated, which is represented in the upper vertical region. However, the embossment does not give rise to a double layer.

Referring to FIG. 11h, the bridge 4 that forms the double layer is pressed inward from both sides and thus divides the hollow profile 1 into the upper hollow chamber 2 and the lower hollow chamber 3 which are L-shaped in cross section.

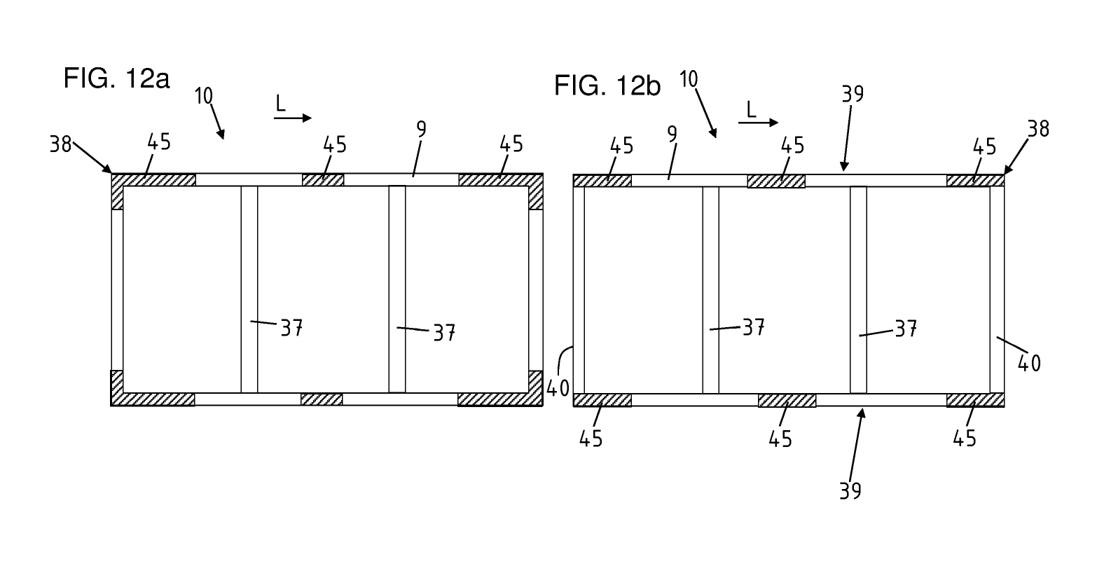

Referring to FIGS. 12a and 12b, a top view of a produced battery tray 10 is illustrated. The battery tray 10 has an outer peripheral frame 9. Cross struts 37 for stiffening and/or for attaching batteries not shown in any greater detail are arranged within the battery tray 10.

The frame 9 is outer peripheral in configuration and has inserts 45, in sections, in its longitudinal direction. The inserts 45 are in particular configured peripherally in a given corner 38. The localized inserts 45 are used for stiffening the hollow profile 1 and when arranged in the outward-facing hollow chamber, they can counteract a penetration or an unacceptable indenting. A patch can also be used instead of the inserts 45. Specifically, a given insert 45 fills the hollow profile 1 in the cross section (of the given hollow chamber) and extends, in sections, in a longitudinal direction L. It is also possible for the hollow profile 1 itself to be ductile, in other words soft, in the area of the inserts 45. It is provided with sufficient rigidity by the insert 45. The soft material structure will allow the connecting components not being torn off.

As shown in FIG. 12b, a given lengthwise side of the frame 9 is formed from the hollow profile 1. A given end face 40 can be produced from a different hollow profile. In this case as well, inserts 45 are formed, in lengthwise sections, in the longitudinal direction of the hollow profile 1, particularly in the area of the corners 38, where a lengthwise side 39 and an end face 40 are connected. A tearing-off or tearing-out is thus prevented, specifically in the event of a crash.

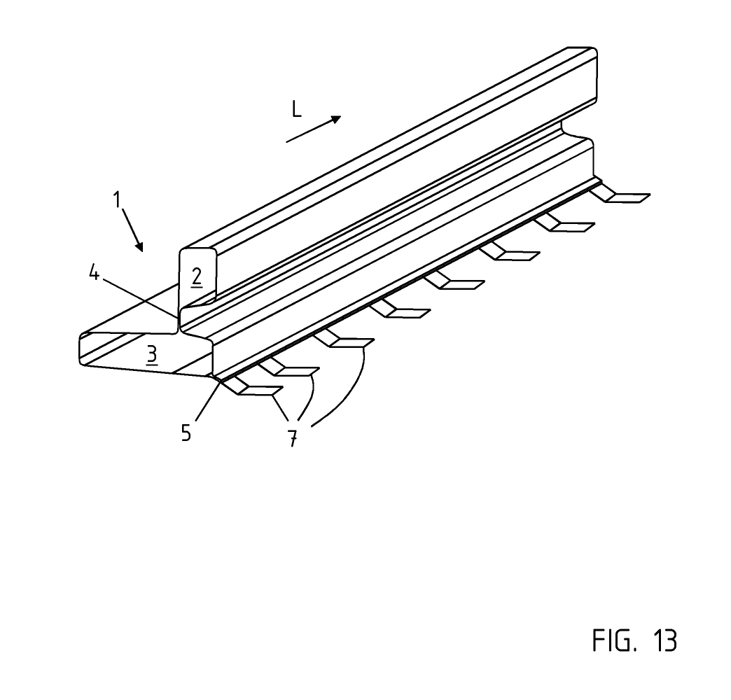

FIG. 13 shows a hollow profile 1 produced according to the invention, in a perspective partial view. Several individual joining tabs 7 projecting from the flange 5, which according to FIG. 3 can be connected to a bottom 17 of a battery tray 10, are formed in a longitudinal direction L on the hollow profile 1. The upper vertical hollow chamber 2 is connected to the lower horizontal hollow chamber 3 via the bridge area 4.

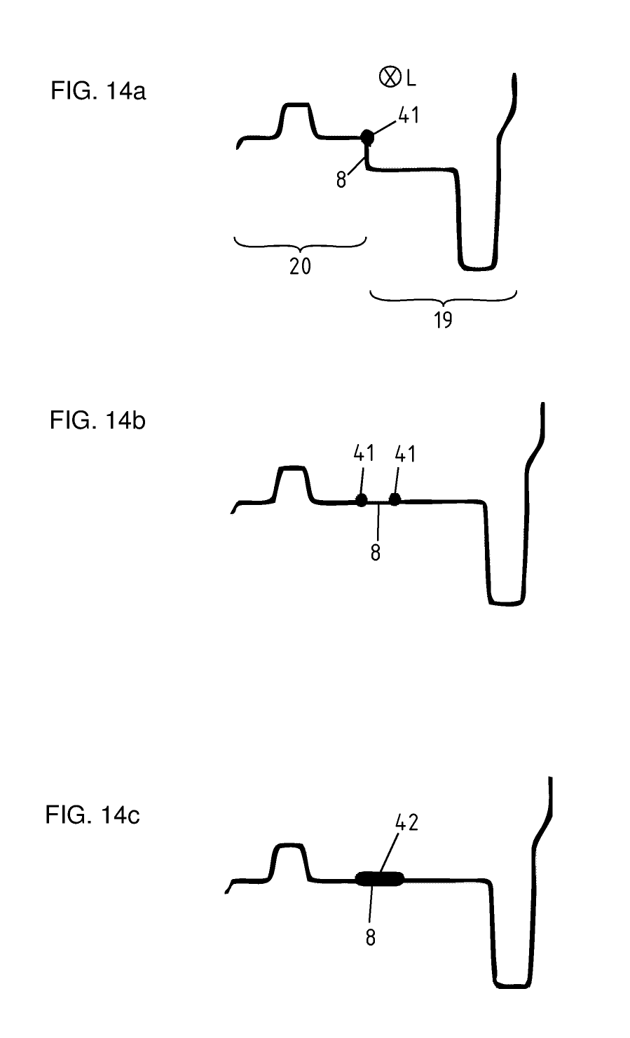

Referring to FIGS. 14a to 14c, a closed hollow profile 1 from a pre-product is shown. A bending operation is performed. A first portion 19 is initially produced by thermoforming and press hardening.

This gives rise to a pre-product with the contour represented in cross section. In each case a soft area 26 is preferably provided in the area of the eventual roof bridge 8. This soft area 26 extends over the entire length of the pre-product, specifically in a longitudinal direction L.

In a subsequent bending operation, two portions 19, 20 are bent about the one bending point 41, which extends in a longitudinal direction L and thus also constitutes a bending line, and come into positive-locking abutment.

Referring to FIG. 14b, two bending points 41 are depicted. These frame the eventual roof bridge 8. To produce the hollow profile 1, an operation of bending about the two bending points 41 is performed.

Referring to FIG. 14c, a bending area 42 is depicted. This bending area 42 likewise extends over the entire length in the longitudinal direction L and represents the area of the eventual roof bridge 8.

1. A hollow profile produced from a hardenable steel alloy blank by thermoforming and press hardening, comprising: an L-shaped cross section with at least one hollow chamber, wherein the hollow profile further includes a tensile strength greater than 1,350 MPa in at least one region.

2. The hollow profile of claim 1, further comprising an upper vertical hollow chamber, a lower horizontal hollow chamber, and that the blank comes in abutment on an intermediate bridge area, forming a double layer, and subdivides the horizontal and vertical hollow chambers.

3. The hollow profile of claim 2, further comprising a flange projecting from the horizontal hollow chamber, wherein the flange is formed by a double layer with joining tabs being arranged on the flange.

4. The hollow profile of claim 3, wherein the horizontal hollow chamber is formed such that it projects laterally with respect to the vertical hollow chamber, and wherein the hollow chamber narrows outwardly toward an outer wall.

5. The hollow profile of claim 4, further comprising an indentation inward-facing bead on an upper portion of the vertical hollow chamber in at least one side wall on both opposing side walls.

6. The hollow profile of claim 5, wherein the upper portion of the vertical hollow chamber includes a roof bridge configured as a soft area a tensile strength RM less than 1000 MPa.

7. The hollow profile of claim 1, wherein the hollow profile is welded, resistance spot welded, laser welded, or roller seam welded.

8. The hollow profile of claim 7, wherein the hollow profile has strengths that differ from one another in certain areas in cross section, and/or that the hollow profile has strengths that differ from one another in certain areas in longitudinal sections.

9. The hollow profile of claim 8, further comprising localized recesses, wherein the horizontal hollow chamber is repeatedly recessed locally in such a way that an outward-facing rib structure is produced.

10. A battery tray for an e-vehicle, comprising: an outer peripheral frame produced, at least in sections, from a hollow profile of claim 1, as well as a bottom connected to the frame, and a cover connected to the frame, wherein the bottom is produced as a deep-drawn well.

11. A method for producing the hollow profile of claim 1, comprising:
providing a hardenable steel alloy blank;
at least partial heating the blank to AC3 temperature;
transferring to a thermoforming and press hardening tool or to a forming station, wherein only a first portion of the blank is formed and hardened;
transferring to another forming tool or to another forming stage and forming of a second portion;
trimming and/or perforating; and,
welding the produced hollow profile.

12. A vehicle battery tray for a vehicle, comprising:
an upper hollow chamber;
a lower hollow chamber;
wherein the upper hollow chamber and the lower hollow chamber are integrally formed from a hardenable steel alloy;
an integrally formed bridge area connects the upper and lower hollow chambers;
wherein the lower hollow chamber laterally projects from the upper hollow chamber so that the battery tray forms an L-shaped configuration.
